(19) United States
(12) Patent Application Publication
(10) Pub. No.: US 2018/0337613 A1
(43) Pub. Date: Nov. 22, 2018

(54) X-RAY SYSTEM WITH SWITCHING DEVICE

(71) Applicant: KONINKLIJKE PHILIPS N.V., EINDHOVEN (NL)

(72) Inventors: PETER LUERKENS, AACHEN (DE); ALBERT GARCIA TORMO, EINDHOVEN (NL); BERND ACKERMANN, AACHEN (DE)

(73) Assignee: KONINKLIJKE PHILIPS N.V., Eindhoven (NL)

(21) Appl. No.: 15/777,765

(22) PCT Filed: Nov. 23, 2016
(86) PCT No.: PCT/EP2016/078556

§ 371 Date: May 21, 2018

(30) Foreign Application Priority Data
Nov. 24, 2015 (EP) 15195984.8

(51) Int. Cl. H02M 7/487; H02M 1/32; H02M 1/12; H05G 1/08; H05G 1/54

(52) U.S. Cl. CPC H02M 7/487; H02M 1/32; H01J 35/045; H05G 1/085; H05G 1/54; H02M 1/12

(57) ABSTRACT

The present invention relates an NPC switching device (10) for an X-ray system (86) with symmetric power supply, wherein the switching device is amended by extra damping resistors (13, 18) in the high voltage rails (24, 28). These resistors act as damping resistors. Thus, they may provide particular damping in combination with the load (100), which is capacitive dominated. Further, an additional inductor (77) may be provided at the output (48) of the NPC switching device allowing a resonant transition. In case the NPC switching device is connected with a grid capacitance of the X-ray system, comprising a cathode (90) and a grid (92), wherein the cathode and the grid form a grid capacitance, overshoot and settling time in the switching device may be controlled and reduced, in particular to a minimum.

### FIELD OF THE INVENTION

The invention relates to a switching device, an X-ray system, a method for controlling the switching device and/or the X-ray system, a computer program element and a computer-readable medium.

### BACKGROUND OF THE INVENTION

In high power devices like X-ray imaging devices, a DC input voltage from an electrical power supply may be transferred into a pulsed output voltage that may have a certain frequency and magnitude. The pulsed output voltage may be used to supply a load, in particular a capacitive dominated load. For example, the pulsed output voltage may be used for operating an X-ray tube.

Neutral-point-clamped (NPC) inverters have received extensive attention in the past in industrial drive areas and power system areas. In view to meet the growing demand for NPC inverters with a high operating frequency, soft switching is coming to be an objective to be achieved.

Document US 2014/0241507 A1 relates to an electrical energy supply system with an NPC inverter.

Document WO 2013026179A1 describes a switching device, comprising a DC supply, a series switching circuit; and a first damping resistor and a second damping resistor wherein the DC supply comprises a positive rail, a neutral rail and a negative rail; wherein the first damping resistor is connected between the positive rail and a first input node of the series switching circuit; wherein the second damping resistor is connected at least indirectly between a second input node of the series switching circuit and the negative rail; and wherein the output is configured to be connected to a load for providing a load current.

### SUMMARY OF THE INVENTION

When operating an NPC inverter with a capacitive dominated load at high switching frequency, losses can grow very high. Further, overshoot or oscillations may occur in the NPC circuit with growing switching frequency. In particular, the overshoot may occur as initial part of ringing, which may happen due to an incomplete ZVT at a final turn-on of a switch of the NPC.

Accordingly, there may be a need to reduce the overshoot or oscillations in the circuit of an NPC when a capacitive dominated load is operated. Thus, the object of the present invention may be to provide a switching device for operating a capacitive dominated load at high frequency with low overshoot in the circuit.

The object of the present invention is solved by the subject-matter of the independent claims, wherein further embodiments are incorporated in the dependent claims.

It should be noted that the following described features of the invention apply also for the system, the method, the computer program element and the computer-readable medium.

According to a first aspect of the invention, a switching device is provided, comprising a DC supply, a series switching circuit, a first damping resistor and a second damping resistor, and a first diode and a second diode. The DC supply comprises a positive rail, a neutral rail and a negative rail. The series switching circuit comprises a first switch, a second switch, a third switch and a fourth switch. The first damping resistor is connected between the positive rail and a first input node of the series switching circuit. The first switch is connected at least indirectly between the first input node and a first node of the series switching circuit. The second switch is connected at least indirectly between the first node and a second node of the series switching circuit. The third switch is connected at least indirectly between the second node and a third node of the series switching circuit. The fourth switch is connected at least indirectly between the third node and a second input node of the series switching circuit. The second damping resistor is connected at least indirectly between the second input node and the negative rail. The first diode is connected at least indirectly between the neutral rail and the first node, such that the first diode passes current from the neutral rail to the first node when forward biased. The second diode is connected at least indirectly between the neutral rail and the third node, such that the second diode passes current from the third node to the neutral rail when forward biased. The second node is at least indirectly connected to an output node of the series switching circuit. The output node is configured to be connected to a load for providing a load current. The switching device comprises a third diode and an fourth diode. The third diode is coupled in parallel with the first damping resistor, such that the third diode passes current from the first input node to the positive rail when forward biased. The fourth diode is coupled in parallel with the second damping resistor, such that the fourth diode passes current from the negative rail to the second input node when forward biased.

As an effect, the first damping resistor and the second damping resistor may provide damping, in particular critical damping, in combination with a load, which may have a high capacitive part or may be capacitive dominated. Accordingly, the first and second damping resistor may eliminate or damp oscillations at the moment, when turning on the first switch or the fourth switch.

As an effect, the third and the fourth diode may eliminate overvoltage across the series switching circuit by dumping inverse current into the positive rail or the negative rail, respectively, in case of slight pulse timing errors and/or arcing.

In an example, the third diode and/or the fourth diode are configured as high voltage diodes. In particular, the third diode and/or the fourth diode are configured for at least approximately half of the voltage difference between the positive rail and the negative rail.

In an example, the DC supply may be formed by its rails.

In an example, a switch, in particular one of the switches of the switching device or a plurality of the switches of the switching device or each of the switches of the switching device, may be formed by a sub-circuit comprising a plurality of switches connected in series and/or in parallel. The switches of such a sub-circuit may be configured to execute a switching action synchronously, and thus acting like a single switch, in particular with higher voltage capabilities.

In an example, at least one of the switches, a plurality of the switches or each switch may be a semiconductor switch, in particular a MOSFET-switch, a FET-switch or an IGBT.

According to an exemplary embodiment of the switching device, the switching device comprises a fifth diode, a sixth diode, a seventh diode and a eighth diode, which are coupled in parallel with the first, second, third, and fourth switches, respectively.

As a result, the fifth, sixth, seventh and eighth diode allow reverse current from the load bypassing the switches and a safe return of energy to the power supply, irrespective of the switch state. The diodes may be formed by intrinsic body diodes of MOSFET switches, or by additional components, e.g. in the case of IGBTs.

According to a further exemplary embodiment of the switching device, the switching device comprises a first parallel circuit and a second parallel circuit. The first parallel circuit comprises a third resistor and a parallel coupled first inductance. The second parallel circuit comprises a fourth resistor and a parallel coupled second inductance. The second switch is connected between the first node and a fourth node of the series switching circuit. The first parallel circuit is connected between the fourth node and the second node. The second parallel circuit is connected between the second node and a fifth node of the series switching circuit. The third switch is connected between the fifth node and the third node.

As an effect, the first parallel circuit and the second parallel circuit may eliminate voltage spikes at the switches, in particular at the second and third switch.

As a further effect, the first parallel circuit and the second parallel circuit may limit switching losses at the switches, in particular at the second switch and the third switch.

According to a further exemplary embodiment of the switching device, the switching device comprises a third inductance, wherein the third inductance is connected at least indirectly between the second node and the output node.

As an effect, in case the load at the output node is capacitive dominated, interference of a switching action between the load and the DC supply can be reduced, and in particular may be little, as a transitional current may be mainly provided by the third inductance. Further, only a little remaining non-regenerative current for recharging parts of the switching chain has to be supplied by the DC supply. Thus, providing a small remaining transitional current at the second node into the positive or negative rail of the DC supply may be provided.

According to a further exemplary embodiment of the switching device, the switching device comprises a fifth resistor, wherein the fifth resistor is connected at least indirectly between the second node and the output node.

In an example, the third inductance and the fifth resistor are connected in series or in parallel between the second node and the output node.

As an effect, the fifth resistor may form a damping element, in order to reduce oscillation at the output node.

According to a second aspect of the invention, an X-ray system is provided. The X-ray system comprises an X-ray anode, an X-ray cathode, a grid and a switching device according to any of the preceding examples. The grid is arranged between the X-ray anode and the X-ray cathode. The grid is at least indirectly connected to the output node of the switching device.

In an example, the grid is formed by an X-ray grid and/or a further electrode.

In an example, the X-ray cathode and the grid may form a grid capacitance.

In an example, the X-ray system comprises an X-ray tube, wherein the X-ray tube comprises the X-ray cathode, the X-ray anode and the grid.

In an example, for a fast control of the X-ray system, adjusting the voltage between the grid and the X-ray cathode may be needed. If the grid capacitance is large and/or a switching frequency for the grid capacitance is high, losses can grow high. Using the switching device of the X-ray system for operating the grid capacitance, thus forming a capacitive load, provides the advantages and effects, which have been described with respect to the switching device. Accordingly, analogous advantages and effects apply for the X-ray system.

According to an exemplary embodiment of the X-ray system, the X-ray system comprises a control unit, wherein the control unit is configured to control the first, second, third and fourth switches.

As an effect, the control unit may control the switches of the switching device, in particular in a predefined sequence, such that a minimum overshoot and a short settling time can be achieved. Further, based on the topology of the switching device, the switching device of the X-ray system, and in particular the damping resistors, may provide damping in combination with the grid capacitance.

As a further effect, the damping resistors may eliminate oscillations at the moment, when turning on either the first switch or the fourth switch.

As a further effect, the third inductance of the switching device may provide the advantage that interference of the switching action between the grid capacitance and the DC supply is low, as transitional current may be mainly provided by the third inductance and only a little remaining non-regenerative current for charging parts of the switching chain has to be supplied by the DC supply. Thus, a small remaining transition current at the second node and/or the output node into the positive or negative rail of the DC supply may be provided.

According to a third aspect of the present invention, a method for controlling the switching device according to the first aspect of the present invention and/or the X-ray system according to the second aspect of the present invention is provided. The method comprises the following steps:
a) switching off the first switch and switching on the third switch at a first state of the series switching circuit, where the first switch and the second switch are turned on and the third switch and the fourth switch are turned off, in order to transfer the series switching circuit to a second state;
b) measuring a time after the transfer of the series switching circuit to the second state as a first time; and
c) switching off the second switch and switching on the fourth switch, when, at the second state of the series switching circuit, the first time reaches a predefined, first threshold time in order to transfer the series switching circuit to a third state.

As a result, the second switch can be turned off and the fourth switch can be turned on before the end of a resonant transition, which reduces or eliminates an overshoot and achieves a minimum settling time, in case the load connected to the output node of the switching device is capacitive dominated, in particular by the grid capacitance of the X-ray system.

In an example, the first threshold time is predefined such that the first threshold time is smaller than a transition time of the resonant transition, which may be defined by the capacitive load and the switching device, in particular with its resistive elements, capacitive elements and/or inductive elements. According to a further exemplary embodiment of the method, the method further comprises the following steps:
d) switching off the fourth switch and switching on the second switch at the third state in order to transfer the series switching circuit to a fourth state;
e) measuring a time after the transfer of the series switching circuit to the fourth state as a second time; and
f) switching off the third switch and switching on the first switch when, at the fourth state of the series switching circuit, the second time reaches a predefined, second threshold time in order to transfer the series switching circuit to the first state.

As a result, the third switch can be turned off and the first switch can be turned on before the end of a further resonant transition, which reduces or eliminates an overshoot and achieves a minimum settling time, in case a load connected to the output node of the switching device is capacitive dominated, in particular by a grid capacitance of the X-ray system.

In an example, the second threshold time is predefined such that the second threshold time is smaller than a transition time of the resonant transition, which may be defined by the capacitive load and the switching device, in particular with its resistive elements, capacitive elements and/or inductive elements.

According to a fourth aspect of the present invention, a method for controlling the switching device according to the first aspect of the present invention and/or the X-ray system according to the second aspect of the present invention is provided. The method comprises the following steps:
a′) switching off the first switch and the second switch and switching on the third switch, at a first state of the series switching circuit, where the first switch and the second switch are turned on and the third switch and the fourth switch are turned off, in order to transfer the series switching circuit to a second state;
b′) measuring a time after the transfer of the series switching circuit to a second state as a first time; and
c′) switching on the fourth switch, when, at the second state of the series switching circuit, the first time reaches a predefined, first threshold time in order to transfer the series switching circuit to a third state.

As a result, the fourth switch can be turned on before the end of a resonant transition, which reduces or eliminates an overshoot and achieves a minimum settling time, in case a load of the switching device, in particular a grid capacitance of the system, is operated.

In an example, the first threshold time is predefined such that the first threshold time is smaller than a transition time of the resonant transition, which may be defined by the capacitive load and the switching device, in particular with its resistive elements, capacitive elements and/or inductive elements.

According to an exemplary embodiment of the method according to the fourth aspect, the method further comprises the following steps:
d′) switching off the third switch and the fourth switch and switching on the second switch at the third state in order to transfer the series switching circuit to a fourth state;
e′) measuring a time after the transfer of the series switching circuit to the fourth state as a second time; and
f′) switching on the first switch, when, at the fourth state of the series switching circuit, the second time reaches a predefined, second threshold time in order to transfer the series switching circuit to the first state.

As a result, the first switch can be turned on before the end of a resonant transition, which reduces or eliminates an overshoot and achieves a minimum settling time, if the load operated by the switching circuit is capacitive dominated, for example by the grid capacitance of the X-ray system.

According to a fifth aspect of the present invention, a computer program element for controlling an apparatus according to one of the preceding examples is provided, which, when being executed by a processing unit, is adapted to perform the method steps according to at least one of the preceding examples.

According to a sixth aspect of the present invention, a computer-readable medium having stored the computer program element is provided.

According to an aspect of the invention, an NPC switching device with symmetric power supply is provided, which is amended by extra damping resistors in the high voltage rails. These resistors act as damping resistors. Thus, they may provide particular damping in combination with the load, which is capacitive dominated. Further, an additional inductor may be provided at the output of the NPC switching device allowing a resonant transition. In case the NPC switching device is connected with a grid capacitance of an X-ray system, comprising a cathode and a grid, wherein the cathode and the grid form a grid capacitance, overshoot and settling time in the switching device may be controlled and reduced, in particular to a minimum.

These and other aspects of the present invention will become apparent from and be elucidated with reference to the embodiments described hereinafter.

### BRIEF DESCRIPTION OF THE DRAWINGS

Exemplary embodiments of the invention will be described in the following with reference to the following drawings:

FIG. 1 schematically illustrates a first example of a circuit diagram of the switching device according to the present invention.

FIG. 2 schematically illustrates a second example of a circuit diagram of the switching device according to the present invention.

FIG. 3 schematically illustrates a third example of a circuit diagram of the switching device according to the present invention.

FIG. 4 schematically illustrates a fourth example of the circuit diagram of the switching device according to the present invention.

FIG. 5 schematically illustrates an example of a circuit diagram of the X-ray system according to the present invention.

FIG. 6 schematically illustrates a first state flow-chart of the method according to the present invention.

FIG. 7 schematically illustrates a first waveform chart of the currents of the switching device according to the present invention.

FIG. 8 schematically illustrates a second waveform chart of the voltages of the switching device according to the present invention.

FIG. 9 schematically illustrates a third waveform chart of the switching states of the switches of the switching device according to the present invention.

FIG. 10 schematically illustrates a second state flow-chart of the method according to the present invention.

FIG. 11 schematically illustrates a third state flow-chart of the method according to the present invention.

FIG. 12 schematically illustrates a fourth waveform chart of the currents of the switching device according to the present invention.

FIG. 13 schematically illustrates a fifth waveform chart of the voltages of the switching device according to the present invention.

FIG. 14 schematically illustrates a sixth waveform chart of the switching states of the switches of the switching device according to the present invention.

FIG. 15 schematically illustrates a fourth state flow-chart of the method according to the present invention.

### DETAILED DESCRIPTION OF EMBODIMENTS

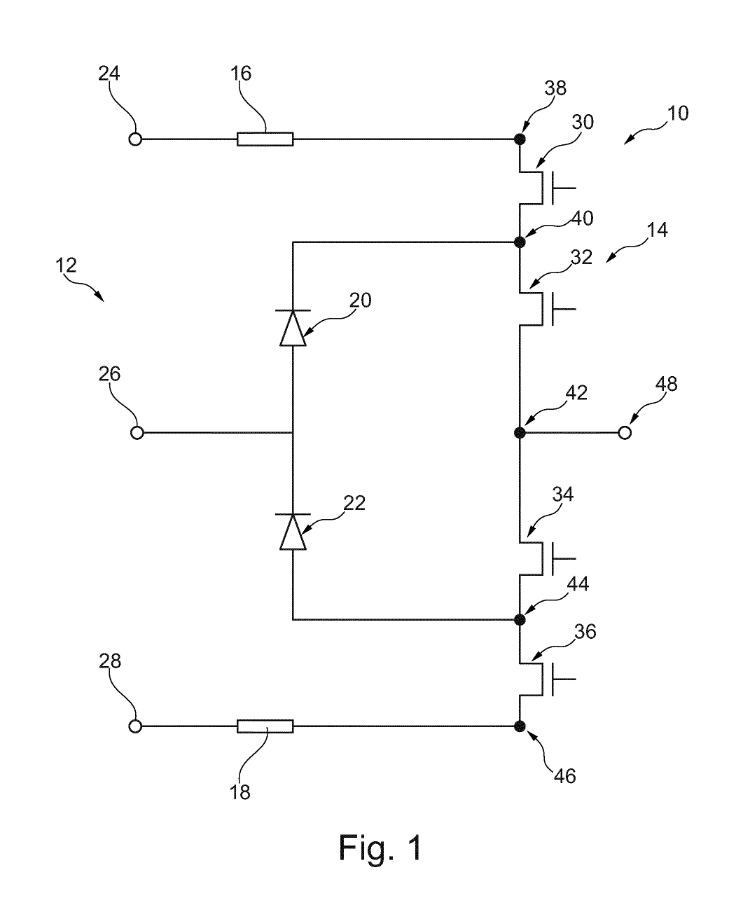

FIG. 1 schematically illustrates a first example of a circuit diagram of the switching device 10 according to the present invention. The switching device 10 comprises: a DC supply 12, a series switching circuit 14, a first damping resistor 16 and a second damping resistor 18, and a first diode 20 and a second diode 22. The DC supply 12 comprises a positive rail 24, a neutral rail 26 and a negative rail 28. The series switching circuit 14 comprises a first switch 30, a second switch 32, a third switch 34 and a fourth switch 36. The first damping resistor 16 is connected between the positive rail 24 and a first input node 38 of the series switching circuit 14. The first switch 30 is connected at least indirectly between the first input node 38 and a first node 40 of the series switching circuit 14. The second switch 32 is connected at least indirectly between the first node 40 and a second node 42 of the series switching circuit 14. The third switch 34 is connected at least indirectly between the second node 42 and a third node 44 of the series switching circuit 14. The fourth switch 36 is connected at least indirectly between the third node 44 and a second input node 46 of the series switching circuit 14. The second damping resistor 18 is connected at least indirectly between the second input node 46 and the negative rail 28. The first diode 20 is connected at least indirectly between the neutral rail 26 and the first node 40, such that the first diode 20 passes current from the neutral rail 26 to the first node 40 when forward biased. The second diode 22 is connected at least indirectly between the neutral rail 26 and the third node 44, such that the second diode 22 passes current from the third node 44 to the neutral rail 26 when forward biased. The second node 42 is at least indirectly connected to an output node 48 of the series switching circuit 14. The output node 48 is configured to be connected to a load for providing a load current.

The DC supply 12 may be formed by its rails 24, 26, 28. The neutral rail 26 may have a voltage of 0 v. The positive rail 24 may have a voltage larger than 0 v. The negative rail 28 may have a voltage lower than 0 v.

In an example, each of the switches 30, 32, 34, 36 may be formed by a sub-circuit comprising a plurality of switches connected in series and/or in parallel. Each of the switches of each sub-circuit may be switched synchronously, thus acting like a single switch.

In an example, a load connectable to the output node 48 of the switching circuit 10 may be capacitive dominated.

As an effect, the resistors 16, 18 may form damping resistors. In particular, they may provide critical damping in combination with a capacitive dominated load. Thus, the resistors 16, 18 may eliminate extra oscillations at the moment when switching the first switch 30 or the fourth switch 36. Accordingly, over the resistors 16, 18, the final charging current has to flow. This eliminates the said extra oscillations.

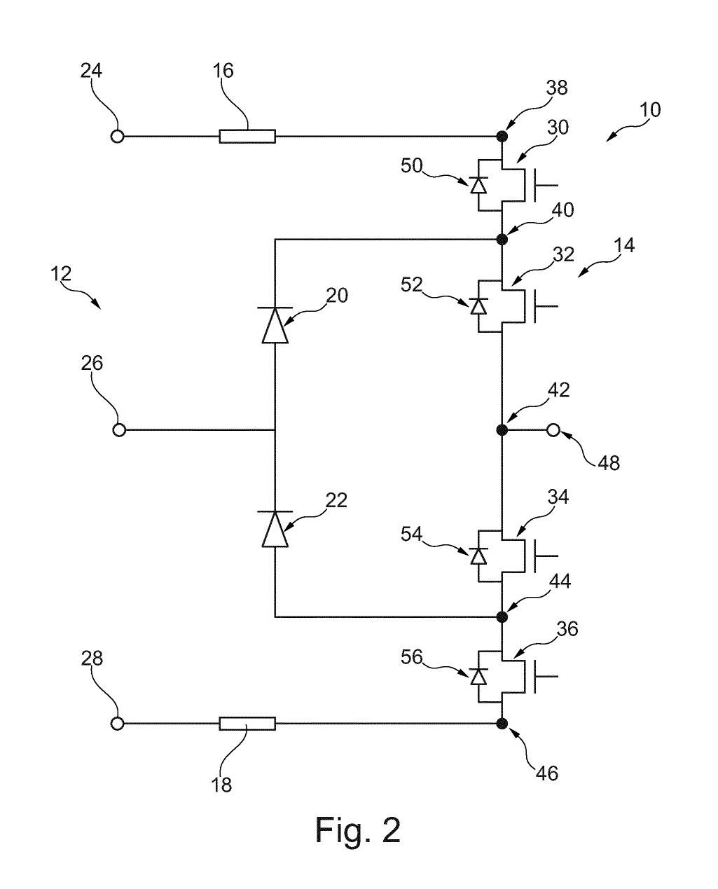

FIG. 2 schematically illustrates a second example of a circuit diagram of the switching device 10 according to the present invention. The circuit diagram basically corresponds to the circuit diagram shown in FIG. 1. The switching device 10 further comprises a fifth diode 50, a sixth diode 52, a seventh diode 54 and a eighth diode 56, which are coupled in parallel with the first, second, third and fourth switches 30, 32, 34, 36, respectively.

As a result, the third, fourth, fifth and eighth diode allow reverse current from the load bypassing the switches and a safe return of energy to the power supply, irrespective of the switch state. The diodes may be formed by intrinsic body diodes of MOSFET switches, or by additional components, e.g. in the case of IGBTs.

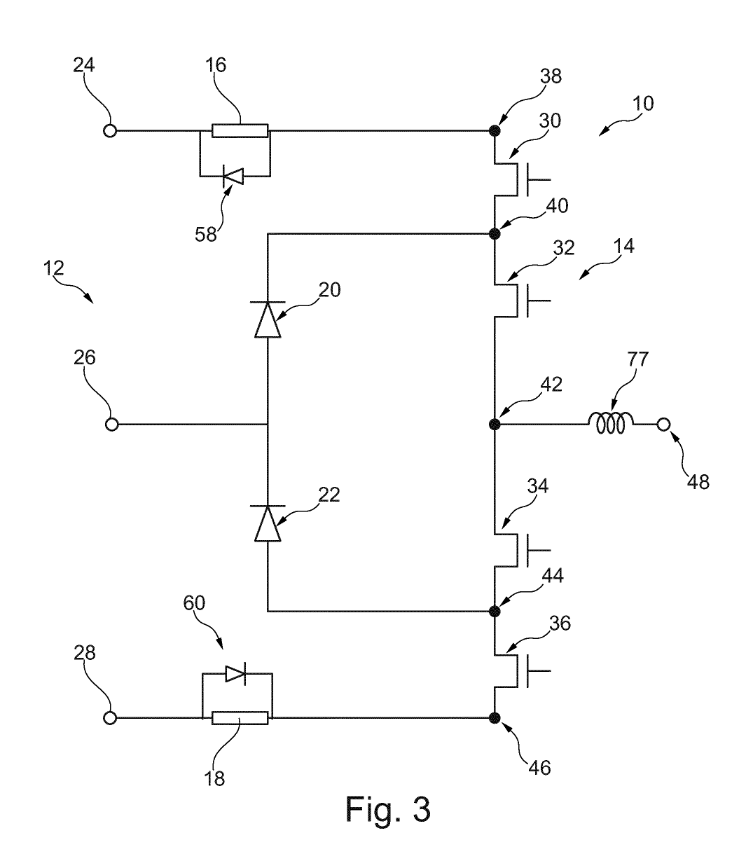

FIG. 3 schematically illustrates a third example of a circuit diagram of the switching device 10 according to the present invention.

According to an exemplary embodiment, the switching device 10 comprises a third diode 58 and an fourth diode 60. The third diode 58 is coupled in parallel with the first damping resistor 16, such that the third diode 58 passes current from the first input node 38 to the positive rail 24 when forward biased. The fourth diode 60 is coupled in parallel with the second damping resistor 18, such that the fourth diode 60 passes current from the negative rail 28 to the second input node 46 when forward biased.

As an effect, the seventh and the fourth diode 58, 60 are configured to eliminate overvoltage across the series switching circuit 14 by dumping inverse current into the positive rail 24 or negative rail 28, respectively, in case slight pulse timing errors or arcing occurs. According to a further exemplary embodiment of the switching device 10, the switching device 10 comprises a third inductance 77, wherein the third inductance 77 is connected at least indirectly between the second node 42 and the output node 48.

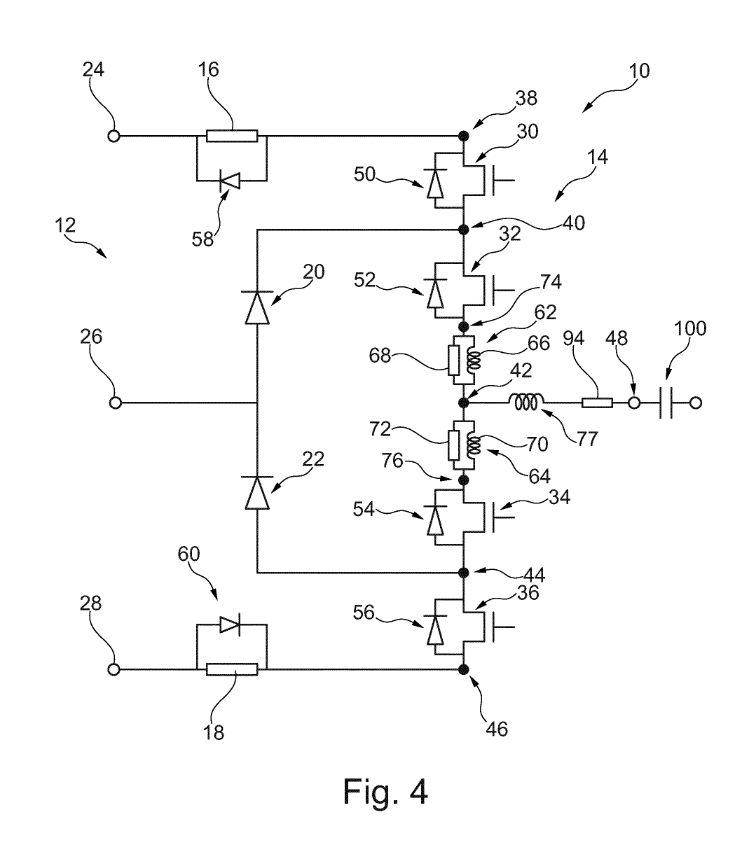

As an effect, in case a load 100 (for example shown in FIG. 4) at the output node 48 is capacitive dominated, interference of the switching action between the load 100 and the DC supply 12 is little, as a transitional current may be mainly provided by the third inductance 77 and only a little remaining non-regenerative current for recharging parts of the switching chain has to be supplied by the DC supply 12, and thus providing a small remaining transitional current at the second node 42 into the positive or negative rail 24, 28 of the DC supply 12.

FIG. 4 schematically illustrates a fourth example of a circuit diagram of the switching device 10.

According to a further exemplary embodiment of the switching device 10, the switching device 10 comprises a first parallel circuit 62 and a second parallel circuit 64. The first parallel circuit 62 comprises a third resistor 68 and a parallel coupled first inductance 66. The second parallel circuit comprises a fourth resistor 72 and a parallel coupled second inductance 70. The second switch 32 is connected between the first node 40 and a fourth node 74 of the series switching circuit 14. The first parallel circuit 62 is connected between the fourth node 74 and the second node 42. The second parallel circuit 64 is connected between the second node 42 and a fifth node 76 of the series switching circuit 14. The third switch 34 is connected between the fifth node 76 and the third node 44.

As an effect, the parallel circuits 62, 64 may eliminate voltage spikes at the switches 30, 32, 34, 36.

As a further effect, the parallel circuits 62, 64 may limit switching losses at the switches 30, 32, 34, 36.

According to a further exemplary embodiment of the switching device 10, the switching device 10 comprises a fifth resistor 94, wherein the fifth resistor 94 is connected at least indirectly between the second node 42 and the output node 48.

In an example, the third inductance 77 and the fifth resistor 94 are connected in series between the second node 42 and the output node 48.

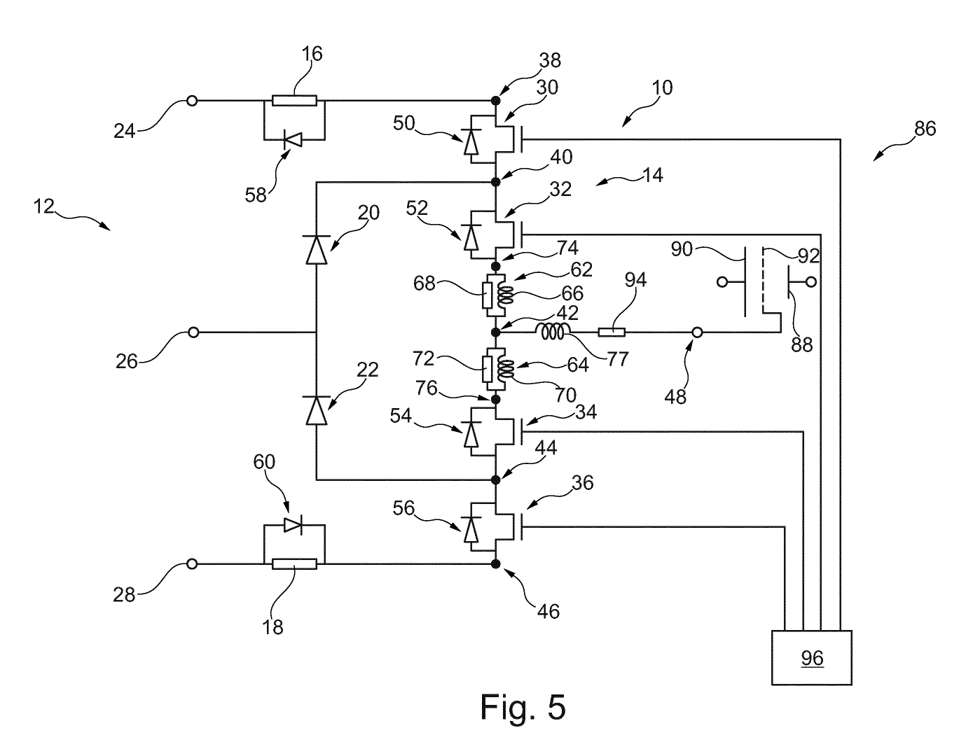

FIG. 5 schematically illustrates an example of a circuit diagram of the X-ray system 86 according to the present invention. The X-ray system 86 comprises an X-ray anode 88, an X-ray cathode 90, a grid 92, and a switching device 10 according to any of the preceding exemplary embodiments of the switching device 10. The grid 92 is arranged between the X-ray anode 88 and the X-ray cathode 90. The grid 92 is at least indirectly connected to the output node 48.

Exposure of an X-ray image depends on the emission current of an X-ray tube, which may comprise the X-ray anode 88 and the X-ray cathode 90. The X-ray tube may be controlled by a heating of the X-ray cathode 90 with a filament. Heating the X-ray cathode 90 may be a process with a slow time constant. In particular, when reducing the emission current, this may be subject to the slow cathode temperature decay, as “negative” heating is often not possible.

Instead, for fast control, the X-ray tube may comprise the grid 92. The grid 92 of the X-ray system 86, and in particular of the X-ray tube, may be formed by a grid electrode. The grid 92 may be configured to convert the X-ray tube from a diode into a triode, which may allow fast emission current modulation by adjusting the voltage between the grid 92 and the X-ray cathode 90. The control of the current may be performed by a control unit 96.

For practical reasons, it is preferred to use the DC supply 12. Further, it may be preferred to use the voltage at the positive rail 24 and the voltage at the negative rail 28 allowing to release the full emission current of the X-ray cathode 90, or to shut it off entirely. For fast control, in particular performed by the control unit 96, the transitions between the voltage levels has to be fast. Electrical charge may be exchanged with the grid 92 during change of the voltage levels, which may lead to a loss. If a corresponding grid capacitance, which may be formed by the X-ray cathode 90 and the grid 92, is small, the loss may be small or acceptable. However, if the grid capacitance is large and/or the switching frequency at the grid 92 is high, the losses may be grown high.

The switching device 10 used for the X-ray system 86 may comprise a symmetric power supply 12, which is preferably amended by damping resistors 16 and 18. The damping resistors 16 and 18 may limit voltage overshoot and ringing in the switching device 10. Accordingly, a small settling time may be achieved. In addition, an inductance 77 may be connected between the second node 42 of the series switching circuit 14 of the switching device 10 and the output node 48, allowing a resonant transition.

The further provided third diode 58 and fourth diode 60 may eliminate overvoltage across the series switching circuit 14 by dumping inverse current into the positive rail 24 or the negative rail 28, respectively, in case of slight pulse timing errors and/or arcing.

According to an exemplary embodiment of the X-ray system 86, the X-ray system 86 comprises a control unit 96, wherein the control unit 96 is configured to control the first, second, third, and fourth switch 30, 32, 34, 36 of the switching device 10.

In an example, the grid 92 may be formed as a grid electrode, in particular providing a mesh form.

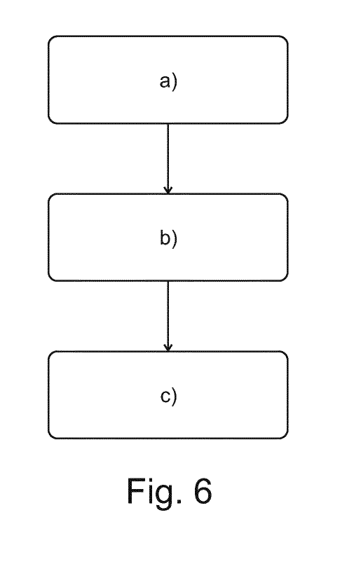

FIG. 6 schematically illustrates a first state flow-chart of the method according to the third aspect of the present invention. This method comprises the following:

In a step a), switching off the first switch 30 and switching on the third switch 34 at a first state of the series switching circuit 14, where the first switch 30 and the second switch 32 are turned on and the third switch 34 and the fourth switch 36 are turned off, in order to transfer the series switching circuit 14 to a second state,

in a step b), measuring a time after the transfer of the series switching circuit 14 to the second state as a first time t₁, and in step c), switching off the second switch 32 and switching on the fourth switch 36, when, at the second state of the series switching circuit 14, the first time ti reaches a predefined, first threshold time t_{1,th} in order to transfer the series switching circuit 14 to a third state.

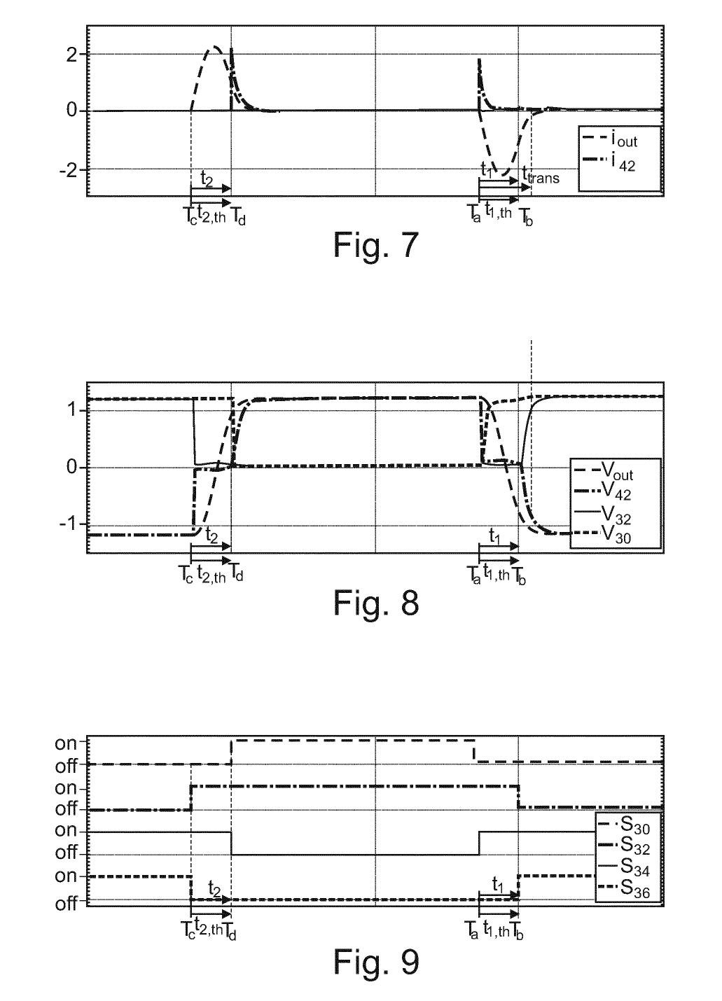

FIG. 7 schematically illustrates a first waveform chart of currents of the switching device 10.

FIG. 8 schematically illustrates a second waveform chart for the voltages of the switching device 10.

In an example, the first threshold time t_{1,th} is smaller than a resonant transition time tₜᵣₐₙₛ for the current iₒᵤₜ or the voltage vₒᵤₜ at the output node 48. Thus, depending on the load 100 and the elements of the switching device 10, the first threshold time t_{1,th} may be determined.

FIG. 9 schematically illustrates a third waveform chart for the switching states of the switches 30, 32, 34, 36.

In view of the waveform charts schematically shown in FIGS. 7, 8 and 9 it can be seen that a resonant transition starts at the time Tₐ, thus when step a) is performed. Accordingly, the resonant transition starts with turning off the first switch 30 and switching on the third switch 34. The capacitive dominated load 100, in particular formed by the X-ray cathode 90 and the grid 92, may be discharged over inductance 77, the third switch 34 and the second diode 22 into the neutral rail 26 of the DC supply 12. Thereby, the current iₒᵤₜ at the output node 48 grows until a maximum is achieved, in particular when the voltage Vₒᵤₜ at the output node 48 is 0. Driven by the inductance 77, the current iₒᵤₜ continues flowing in the same direction and starts to charge the capacitive dominated load 100 to a negative voltage of the voltage Vₒᵤₜ, while the current iₒᵤₜ decays.

A resonant transition time tₜᵣₐₙₛ can be predetermined by the capacitive dominated load 100, in particular by the capacitance formed by the X-ray cathode 90 and the grid 92, and the elements of the switching device 10, in particular by the fifth resistor 94, and/or the inductance 77, more particularly by also considering the resistance 68, 72 and inductance 66, 70 of the first parallel circuit 62 and the second parallel circuit 64, respectively. As can be seen from FIGS. 7 to 9, the first threshold time t_{1,th} is predefined as smaller than the resonant transition time tₜᵣₐₙₛ.

Further, FIGS. 7 to 9 schematically show, that the step a) is performed at time Tₐ. Thus, the measuring of the first time ti starts with the time Tₐ. If the first time ti reaches the predefined, first threshold time t_{1,th}, step c) is performed and the second switch 32 is switched off as well as the fourth switch 36 is switched on. Switching on the fourth switch 36 allows to charge the capacitive dominated load 100. Preferably, said capacitance is fully charged to the negative voltage supplied by the negative rail 28 of the DC supply 12.

As a result, the second switch 32 is turned off and the fourth switch 36 is turned on before the end of the resonant transition, and in particular before the first time t₁ reaches the end of the transition time tₜᵣₐₙₛ, but by reaching the predefined, first threshold time t_{1,th}, which is smaller than the resonant transition time tₜᵣₐₙₛ. By turning off the second switch 32 and turning on the fourth switch 36 before the end of the resonant transition, overshoot is eliminated and a minimum settling time can be achieved.

FIG. 7 also schematically illustrates the current I₄₂ at the positive rail 24. FIG. 8 also schematically illustrates the voltage V₄₂ at the second node 42, the voltage V₃₂ between the terminals of the second switch 32, in particular between the first node 40 and the fourth node 74, and the voltage V₃₀ at between the terminals of the first switch 30, in particular between the first input node 38 and the first node 40.

FIG. 9 schematically shows the switching states S30, S32, S34, S36 of the switches 30, 32, 34, 36, respectively.

In an example, instead of “measuring a time after the transfer of the series switching circuit 14 to the second state as a first time t₁” in step b), step b) may be defined as “determining the output current iₒᵤₜ at the output node 48 at the second state of the series switching circuit 14”. Further, the text passage “the first time t₁ reaches a predefined, first threshold time t_{1,th} in order to transfer the series switching circuit 14 to a third state” of step c), may be adapted, such that step c) may be specified by the text passage “a magnitude of the output current iₒᵤₜ reaches a predefined, threshold current in order to transfer the series switching circuit 14 to a third state”. Thus, the change from the second state to the third state may be performed based on the output current iₒᵤₜ at the output node 48 and the corresponding predefined threshold current.

In an example, determining the output current iₒᵤₜ at the output node 48 may be performed by at least indirectly sensing output current iₒᵤₜ at the output node 48.

In a further example, determining the output current iₒᵤₜ at the output node 48 may be performed by calculating the output current iₒᵤₜ at the output node 48 based on a change from the first state to the second state and predefined circuit parameters of the switching device 10 and/or the capacitive dominated load 100. Thus, the output current iₒᵤₜ at the output node 48 may be determined by an off-line pre-calculation of the corresponding current waveform at which a desired current has established.

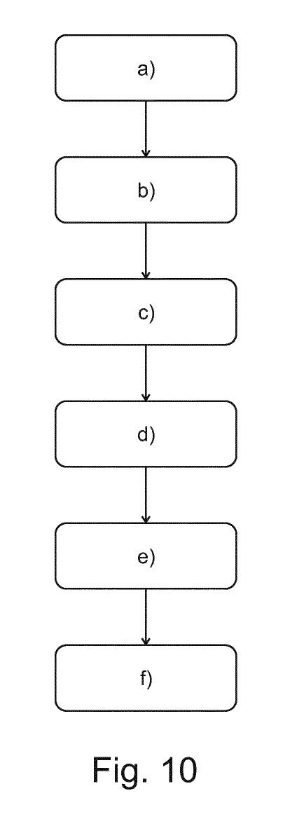

FIG. 10 schematically illustrates a second state flow-chart of a method according to the third aspect of the present invention, wherein the steps a), b) and c) refer to the steps as explained previously.

According to an example of the method according to the third aspect of the present invention, this method comprises the following:

step d) switching off the fourth switch 36 and switching on the second switch 32 at the third state in order to transfer the series switching circuit 10 to a fourth state;

in step e) measuring a time after the transfer of the series switching circuit to the fourth state as a second time t₂; and

in step f) switching off the third switch 34 and switching on the first switch 30, when, at the fourth state of the series switching circuit 14, the second time t₂ reaches a predefined, second threshold time t_{2,th} in order to transfer the series switching circuit 14 to the first state.

FIG. 9 schematically illustrates at time T_{c} that the fourth switch 36 is switched off and the second switch 32 is switched on. By switching off the fourth switch 36 and switching on the second switch 32, a further resonant transition starts. The capacitive dominated load 100, in particular the capacitance formed by the X-ray cathode 90 and the grid 92, is charged over the switching device 10, in particular over the fifth resistance 94, the inductance 77 and the first diode 20 by the neutral rail 26 of the DC supply 12. The current iₒᵤₜ at the output node 48 grows until a maximum is achieved, in particular when the voltage Vₒᵤₜ at the output node is 0 v. Driven by the inductance 77, the current iₒᵤₜ may continue flowing in the same direction and starts to charge the capacitive dominated load 100 to a positive voltage, while the current iₒᵤₜ decays.

In an example, the predefined, second threshold time t_{2,th} corresponds to the predefined, first threshold time t_{1,th}. As a result, the third switch 34 is switched off and the first switch 30 is switched on before the end of the resonant transition tₜᵣₐₙₛ, which eliminates overshoot and/or may achieve a minimum settling time.

Interference of the switching action with respect to the described method steps, in particular with respect to the capacitive dominated load 100 and the DC supply 12 is little, as a transitional current may flow, at least primarily, into the neutral rail 26, while little remaining non-regenerative current for recharging parts for the switching may have to be applied by the DC supply 12.

In an example, in step e) instead of “measuring a time after the transfer of the series switching circuit 14 to the fourth state as a second time t₂” “determining the output current iₒᵤₜ at the output node 48 at the fourth state of the series switching circuit 14” is performed. Further, the feature “the second time t₂ reaches a predefined, second threshold time t_{2,th} in order to transfer the series switching circuit 14 to the first state” of step f) may be replaced by the feature “a magnitude of the output current iₒᵤₜ at the output node 48 reaches a predefined, second threshold current in order to transfer the series switching circuit 14 to the first state”.

In an example, determining the output current iₒᵤₜ at the output node 48 may be performed by at least indirectly sensing the output current at the output node 48.

In a further example, the output current iₒᵤₜ at the output node 48 may be determined by off-line pre-calculation of a current waveform at which a desired current has established.

In a further example, determining the output current iₒᵤₜ at the output node 48 may be performed by calculating the output current iₒᵤₜ at the output node 48 based on a change from the third state to the fourth state and predefined circuit parameters of the switching device 10 and/or the capacitive dominated load 100.

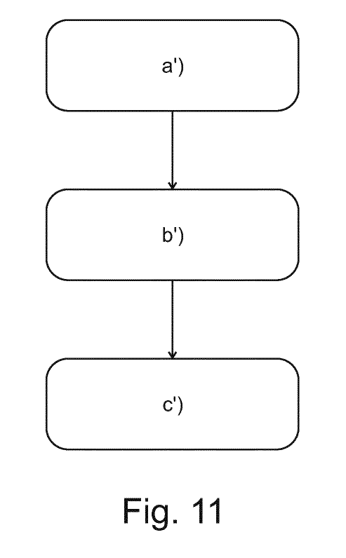

The following explanation with respect to the FIGS. 11 to 15 relates to an alternative embodiment of the method according to the fourth aspect of the present invention. Due to their similarity, reference to the above explanations of the method according to the third aspect of the present invention is made, where it is appropriate.

FIG. 11 schematically illustrates a third state flow-chart for the method according to the fourth aspect of the present invention. The method comprises the following steps:
a′) switching off the first switch 30 and the second switch 32 and switching on the third switch 34 at a first state of the series switching circuit 14, where the first switch 30 and the second switch 32 are turned on and the third switch 34 and the fourth switch 36 are turned off, in order to transfer the series switching circuit 14 to a second state,
b′) measuring a time after the transfer of the series switching circuit 14 to a second state as a first time t′₁, and
c′) switching on the fourth switch 36, when, at the second state of the series switching circuit 14, the first time t′₁ reaches a predefined, first threshold time t′_{1,th} in order to transfer the series switching circuit 14 to a third state.

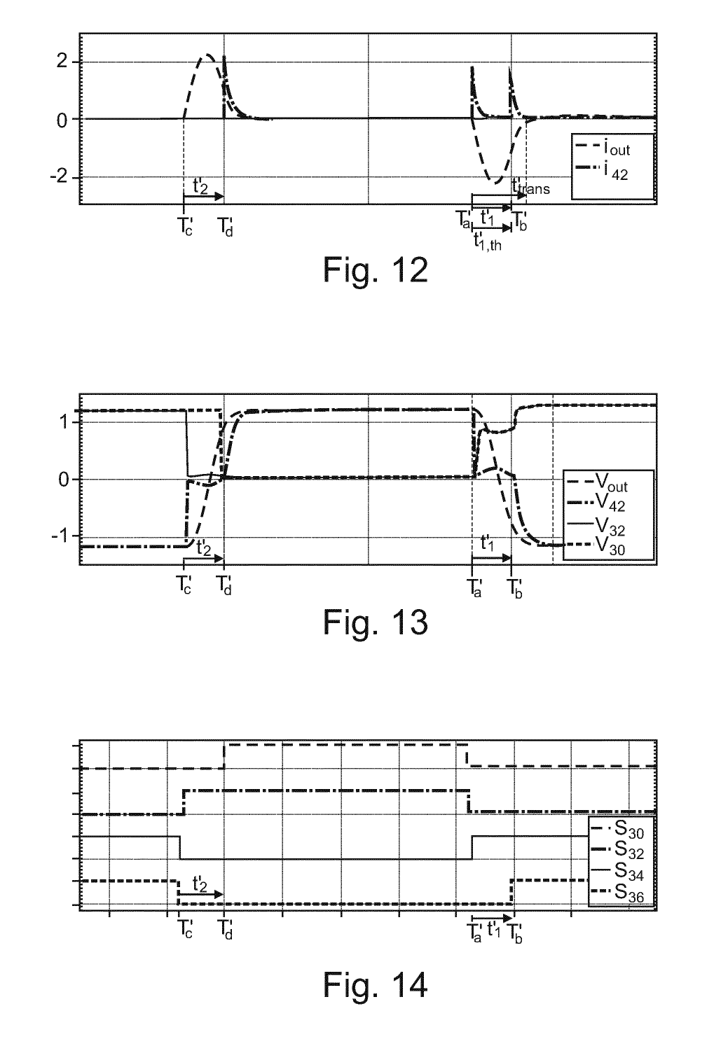

FIG. 12 schematically illustrates a fourth waveform chart for the currents corresponding to the method according to the fourth aspect of the present invention.

FIG. 13 schematically illustrates a fifth waveform chart of the voltages corresponding to the method according to the fourth aspect of the present invention.

FIG. 14 schematically illustrates a sixth waveform chart for the switching states of the switches according to the method according to the fourth aspect of the present invention.

With respect to the FIGS. 12, 13 and 14, at the time T′ₐ, the series switching circuit 14 is in its first state. In particular in FIG. 14, the signal lines S30, S32, S34 and S34 correspond to the switching states of the switches 30, 32, 34 and 36, respectively.

The transfer from the first state of the series switching circuit 14 to the second state of the series switching circuit 14 occurs at the time T′ₐ. At the same time, a resonant transition starts with switching off of the first switch 30, switching off of the second switch 32 and switching on of the third switch 34. The capacitive dominated load 100, in particular the capacitance formed by the X-ray cathode 90 and the grid 92, is discharged thereupon over the inductance 77, the third switch 34 and the second diode 22 into the neutral rail 26 of the DC supply 12. Driven by the inductance 77, the current may continue flowing in the same direction and starts to charge the capacitive dominated load 100 to a negative voltage, while the current decays.

The resonant transition of the current preferably corresponds to a transition time tₜᵣₐₙₛ. The transition time may be predetermined by the capacitive dominated load 100 and the elements of the switching device 10, in particular by the fifth resistor 94 and/or the inductance 77. Preferably, the predefined, first threshold time t′_{1,th} is smaller than the transition time tₜᵣₐₙₛ.

As a result, the fourth switch 36 is turned on before the end of the resonant transition, which has been started in step a′), in order to reduce or eliminate overshoot and/or to achieve a minimum settling time.

Switching on the fourth switch 36 allows to charge the capacitive dominated load 100 further, in particular to fully charge it, to the negative voltage of the negative rail 28 of the DC supply 12.

In an example, in step b′) instead of “measuring a time after the transfer of the series switching circuit 14 to the second state as a first time t′₁” “determining the output current iₒᵤₜ at the output node 48 at the second state of the series switching circuit 14” is performed. Further, in step c′), the feature “the first time t′₁ reaches a predefined, first threshold time t′_{1,th} in order to transfer the series switching circuit 14 to a third state” is replaced by the feature “a magnitude of the output current iₒᵤₜ at the output node 48 reaches a predefined, threshold current in order to transfer the series switching circuit 14 to a third state”. With respect to the effects and advantages, reference is made in analogous manner to the first embodiment of the method according to the third aspect of the present invention.

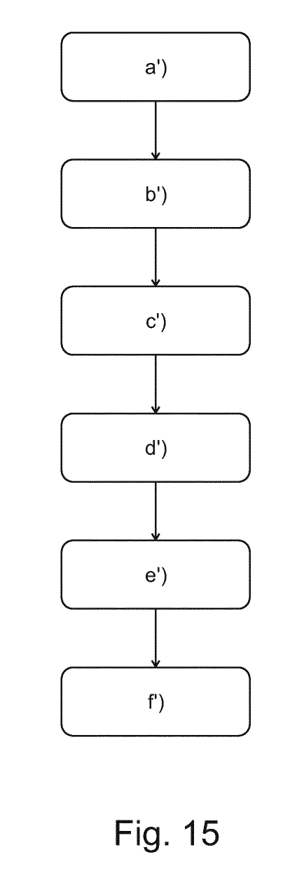

FIG. 15 schematically illustrates a fourth state flow chart for a further example of the method according to the fourth aspect of the present invention.

According to the further example of the method according to the fourth aspect of the present invention, the method comprises the following further steps:
d′) switching off the third and the fourth switch and switching on the second switch at the third state in order to transfer the series switching circuit 14 to a fourth state;
e′) measuring a time after the transfer of the series switching circuit to the fourth state as a second time t′₂; and
f′) switching on the first switch 30, when, at the fourth state of the series switching circuit 14, the second time t′₂ reaches a predefined, second threshold time t′_{2,th} in order to transfer the series switching circuit to the first state.

Switching off the third and the fourth switch 34, 36 and switching on the second switch 32 will cause another resonant transition, beginning at the time T′_{c}. The capacitive dominated load 100 is charged there upon over the inductance 77, the second switch 32 and the first diode 20 to the neutral rail 26 of the DC supply 12. Thereby, the output current iₒᵤₜ at the output node 48 grows until a maximum is achieved, in particular when the outer volume Vₒᵤₜ at the output node 48 is 0 v. Driven by the inductance 77, the output current iₒᵤₜ continues flowing in the same direction and starts to charge the capacitive dominated load 100 to a positive voltage, while the output current iₒᵤₜ decays.

When the second time t′₂ reaches the predefined, second threshold time t′_{2,th}, which in particular corresponds to the predefined, first threshold time t′_{1,th,} the first switch 30 is switched on.

As a result, the first switch 30 is turned on before the end of the corresponding resonant transition, which eliminates overshoot and/or achieves a minimum settling time.

In an example, in step e′), the feature “measuring a time after the transfer of the series switching circuit to the fourth state as a second time t′₂” is replaced by the feature “determining the output current iₒᵤₜ at the output node 48 at the fourth state of the series switching circuit 14”. Further, in step f′), the feature “the second time t′₂ reaches a predefined, second threshold time t′_{2,th}” is preferably replaced by the feature “a magnitude of the output current iₒᵤₜ at the output node 48 reaches a predefined, threshold current”.

Due to the analogous, preferred configuration of the fourth aspect of the present invention, in particular of its examples, to the third aspect of the present invention, reference is made in analogous manner to the respective examples and preferred features.

According to a further example of the present invention, a computer program element is provided, which, when being executed by a processing unit, is adapted to carry out at least one of the preferred embodiments of the method according to the present invention.

According to a further example of the present invention, a computer-readable medium having stored thereon the program element is provided, which, when being executed by a processing unit, is adapted to carry out at least one example or embodiment of the method of the present invention.

The computer program element might be stored on a computer unit, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

It has to be noted that embodiments of the invention are described with reference to different subject matters. In particular, some embodiments are described with reference to a device whereas other embodiments are described with reference to the method. However, a person skilled in the art will gather from the above that, unless otherwise notified, in addition to any combination of features belonging to one subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A switch or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. (canceled)

2. The switching device according to claim 15, comprising a fifth diode, a sixth diode, a seventh diode and an eighth diode, which are coupled in parallel with the first, second, third, and fourth switches, respectively.

3. The switching device according to claim 15, further comprising a first parallel circuit and a second parallel circuit, wherein the first parallel circuit comprises a third resistor and a parallel coupled first inductance, wherein the second parallel circuit comprises a fourth resistor and a parallel coupled second inductance, wherein the second switch is connected between the first node and a fourth node of the series switching circuit, wherein the first parallel circuit is connected between the fourth node and the second node, wherein the second parallel circuit is connected between the second node and a fifth node of the series switching circuit, and wherein the third switch is connected between the fifth node and the third node.

4. The switching device according to claim 15, comprising a third inductance connected between the third node and the output node.

5. The switching device according to claim 15, comprising a fifth resistor connected between the second node and the output node.

6. (canceled)

7. The X-ray system according to claim 16, comprising a control unit configured to control the first, second, third and fourth switch.

8. (canceled)

9. (canceled)

10. The method according to claim 17, further comprising:
switching off the fourth switch and switching on the second switch at the third state in order to transfer the series switching circuit to a fourth state;
measuring a time after the transfer of the series switching circuit to the fourth state as a second time; and
switching off the third switch and switching on the first switch, when, at the fourth state of the series switching circuit, the second time reaches a predefined, second threshold in order to transfer the series switching circuit to the first state.

11. (canceled)

12. The method according to claim 18, further comprising:
switching off the third and the fourth switch and switching on the second switch at the third state in order to transfer the series switching circuit to a fourth state;
measuring a time after the transfer of the series switching circuit to the fourth state as a second time; and
switching on the first switch, when, at the fourth state of the series switching circuit, the second time reaches a predefined, second threshold in order to transfer the series switching circuit to the first state.

13. (canceled)

14. (canceled)

15. A switching device, comprising:
a DC supply comprising a positive rail, a neutral rail and a negative rail;
a series switching circuit comprising:
a first switch connected between a first input node and a first node of the series switching circuit;
a second switch connected between the first node and a second node of the series switching circuit;
a third switch connected between the second node and a third node of the series switching circuit; and
a fourth switch connected between the third node and a second input node of the series switching circuit;
a first damping resistor connected between the positive rail and a first input node of the series switching circuit;
a second damping resistor connected between the second input node and the negative rail;
a first diode connected between the neutral rail and the first node, such that the first diode passes current from the neutral rail to the first node when forward biased;
a second diode connected between the neutral rail and the third node, such that the second diode passes current from the third node to the neutral rail when forward biased, wherein the second node is connected to an output node of the series switching circuit, and wherein the output node is configured to be connected to a load for providing a load current;
a third diode coupled in parallel with the first damping resistor, such that the third diode passes current from the first input node to the positive rail when forward biased; and
a fourth diode coupled in parallel with the second damping resistor, such that the fourth diode passes current from the negative rail to the second input node when forward biased.

16. An X-ray system, comprising:
an X-ray anode;
an X-ray cathode;
a grid; and
a switching device, comprising:
a DC supply comprising a positive rail, a neutral rail and a negative rail;
a series switching circuit comprising:
a first switch connected between a first input node and a first node of the series switching circuit;
a second switch connected between the first node and a second node of the series switching circuit;
a third switch connected between the second node and a third node of the series switching circuit; and
a fourth switch connected between the third node and a second input node of the series switching circuit;
a first damping resistor connected between the positive rail and a first input node of the series switching circuit;
a second damping resistor connected between the second input node and the negative rail;
a first diode connected between the neutral rail and the first node, such that the first diode passes current from the neutral rail to the first node when forward biased;
a second diode connected between the neutral rail and the third node, such that the second diode passes current from the third node to the neutral rail when forward biased, wherein the second node is connected to an output node of the series switching circuit, and wherein the output node is configured to be connected to a load for providing a load current;
a third diode coupled in parallel with the first damping resistor, such that the third diode passes current from the first input node to the positive rail when forward biased; and
a fourth diode coupled in parallel with the second damping resistor, such that the fourth diode passes current from the negative rail to the second input node when forward biased;
wherein the grid is arranged between the X-ray anode and the X-ray cathode; and wherein the grid is connected to the output node.

17. A method for controlling a switching device, comprising:
providing a DC supply comprising a positive rail, a neutral rail and a negative rail;
providing a series switching circuit comprising:
a first switch connected between a first input node and a first node of the series switching circuit;
a second switch connected between the first node and a second node of the series switching circuit;
a third switch connected between the second node and a third node of the series switching circuit; and
a fourth switch connected between the third node and a second input node of the series switching circuit;
providing a first damping resistor connected between the positive rail and a first input node of the series switching circuit;
providing a second damping resistor connected between the second input node and the negative rail;
providing a first diode connected between the neutral rail and the first node, such that the first diode passes current from the neutral rail to the first node when forward biased;
providing a second diode connected between the neutral rail and the third node, such that the second diode passes current from the third node to the neutral rail when forward biased, wherein the second node is connected to an output node of the series switching circuit, and wherein the output node is configured to be connected to a load for providing a load current;
providing a third diode coupled in parallel with the first damping resistor, such that the third diode passes current from the first input node to the positive rail when forward biased;
providing a fourth diode coupled in parallel with the second damping resistor, such that the fourth diode passes current from the negative rail to the second input node when forward biased;
switching off the first switch and switching on the third switch at a first state of the series switching circuit, where the first switch and the second switch are turned on and the third switch and the fourth switch are turned off in order to transfer the series switching circuit to a second state;
measuring a time after the transfer of the series switching circuit to the second state as a first time; and
switching off the second switch and switching on the fourth switch, when, at the second state of the series switching circuit, the first time reaches a predefined first threshold in order to transfer the series switching circuit to a third state.

18. A method for controlling a switching device, comprising:
providing a DC supply comprising a positive rail, a neutral rail and a negative rail;
providing a series switching circuit comprising:
a first switch connected between a first input node and a first node of the series switching circuit;
a second switch connected between the first node and a second node of the series switching circuit;
a third switch connected between the second node and a third node of the series switching circuit; and
a fourth switch connected between the third node and a second input node of the series switching circuit;
providing a first damping resistor connected between the positive rail and a first input node of the series switching circuit;
providing a second damping resistor connected between the second input node and the negative rail;
providing a first diode connected between the neutral rail and the first node, such that the first diode passes current from the neutral rail to the first node when forward biased;
providing a second diode connected between the neutral rail and the third node, such that the second diode passes current from the third node to the neutral rail when forward biased, wherein the second node is connected to an output node of the series switching circuit, and wherein the output node is configured to be connected to a load for providing a load current;
providing a third diode coupled in parallel with the first damping resistor, such that the third diode passes current from the first input node to the positive rail when forward biased;
providing a fourth diode coupled in parallel with the second damping resistor, such that the fourth diode passes current from the negative rail to the second input node when forward biased;
switching off the first and the second switch;
switching on the third switch at a first state of the series switching circuit, where the first switch and the second switch are turned on and the third switch and the fourth switch are turned off in order to transfer the series switching circuit to a second state;
measuring a time after the transfer of the series switching circuit to the second state as a first time; and
switching on the fourth switch, when, at the second state of the series switching circuit, the first time reaches a predefined, first threshold in order to transfer the series switching circuit to a third state.
